(19) United States
(12) Patent Application Publication
(10) Pub. No.: US 2007/0267072 A1
(43) Pub. Date: Nov. 22, 2007

(54) DEVICE FOR CONTROLLING A PAPER CUTTING MACHINE

(75) Inventor: Lothar Michaelis, Wilhelmshaven (DE)

Correspondence Address: VIDAS, ARRETT & STEINKRAUS, Suite 2000, 6109 Blue Circle Drive, Minnetonka, MN, 55343-9185, US

(73) Assignee: Wessel-Hydraulik GmbH, Wilhelmshaven (DE)

(21) Appl. No.: 11/748,581

(22) Filed: May 15, 2007

(30) Foreign Application Priority Data
May 20, 2006 (DE) 10 2006 023 798.6

(51) Int. Cl. F15B 20/00

(52) U.S. Cl. 137/596

(57) ABSTRACT

A device for controlling a paper cutting machine which has a press-down bar and a cutting bar, wherein the press-down bar is operable by a spring-biased single-side action hydraulic press cylinder and the cutting bar is operable by a rotary motor which is adapted to be coupled to a cutting bar via a gearcase and a friction clutch, and wherein the friction clutch is operable by a hydraulic coupling cylinder biased by a spring, comprising a hydraulic pressure source which is connected to the press cylinder via a first pressure line and a controllable on-off valve, two parallel controllable circulation valves which are connected to the pressure line and join the pressure line to the tank when at rest, a controllable cutting simulator valve assembly which restricts the pressure from the press cylinder and the volume of hydraulic medium flowing thereto, a second pressure line leading to the coupling cylinder and joined to the first hydraulic pressure source or a separate second hydraulic pressure source, two controllable second circulation valves which are connected to the pressure line which and join the second pressure line to the tank when at rest, and a control device for driving the individual controllable valves, characterized in that at least one of the first circulation valves is defined by an electrically controllable proportional valve and an electric control device is provided, at least for driving the proportional valve.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

Paper cutting machines, which are also referred to as guillotine type cutters, have a press-down (hold-down) bar and a cutting bar. The two bars are caused to move from an upper dead-centre position to a lower dead-centre position, and vice versa. It is known to move the press-down bar to the lower dead-centre position by means of a hydraulic cylinder and to cause the return stroke to be carried out via a spring. Commonly, the cutting bar is operated by a rotary motor which is coupled to the cutting bar via a gearbox. The drive train has arranged therein a friction clutch which is actuated by a hydraulic cylinder (coupling cylinder). An inertia mass usually is seated, as an energy storage device, on the shaft of the driving motor.

In a cutting operation, the press-down bar initially is caused to move onto the underlying paper stack at an advance in time which is from 0.5 to 1.0 second, for example. The clamping force is determined by the hydraulic pressure adjusted The pressure has to be so large that the stack will not get displaced while being cut and, on the other hand, damage will not be caused to the material being cut. The knife is moved downwards at a time delay by means of the motor and worm gear and crank mechanism. The cut is performed as soon as the knife of the cutting bar reaches the stack. During this phase, it is necessary for the coupling cylinder to produce a sufficient coupling pressure so that a sufficient frictional contact takes place in the coupling. The cutting operation is terminated when the knife has arrived at its lower dead-centre. The knife contacts a plastic strip (cutter strip) there and moves upwards subsequently.

While the cutting bar is moving upwards the press-down bar remains on the stack to prevent the cutting material from getting displaced. Once the cutting bar arrives at the upper dead-centre position the press-down bar is enabled for its return stroke. The return stroke is taken care of by a spring which interacts with the press cylinder.

Devices for controlling a paper cutting machine as was explained above are described in DE 198 53 136, the entire contents of which is incorporated herein by reference, DE 195 33 252, the entire contents of which is incorporated herein by reference, amongst others. In addition, such a state of the art can also be found in O+P “Ölhydraulik und Pneumatik” 40 (1996), No. 4, pages 249 to 252, the entire contents of which is incorporated herein by reference. Reference thereto will briefly be made below.

It is known to incorporate two circulation valves into the pressure line between the pump and press cylinder that couple the pressure line to the tank in parallel when in the opened position. The twin arrangement of the circulation valves is provided for safety reasons if a valve fails. For example, the circulation valves are also driven, for example, to prevent a press-down bar from being actuated or from continuing to move during its actuation because a part of the body gets below the press-down bar, for example. As is known this is ascertained by an optical barrier or the like. When the press-down bar is being driven it is acted on by the pressure of the hydraulic pump. To prevent the press-down bar from being accelerated too much at the beginning of its movement, which can result in a non-uniform movement, it is known to connect a pressure reservoir in parallel, by which a pressure buildup will take place only gradually within the press cylinder.

If as many cuttings as possible per unit time are to be achieved the press-down bar is raised only by a small distance with respect to the paper stack at the end of a cutting. This avoids the travel time of the press-down bar to the upper dead-centre position as well as the time for a full working stroke. An additional valve assembly is necessary to achieve such an optimization (optimization of cuttings).

Likewise, a valve assembly is provided which reduces the speed of the press-down bar before it is put down in order to prevent damage by the press-down bar being let down onto sensitive cutting materials such as sheets, copying paper or art paper at an excessively large pressure.

Also known is a so-called cutting simulator function in paper cutting machines during which the press-down bar is moved down onto the table from the upper dead-centre position to the lower dead-centre position by means of a foot pedal. At this stage, a working pressure between 10 and 20 bars is generated by means of a slide, depending on the position thereof. During this function, the operator may orient the paper stack by hand, for example, and prepare it for the cutting process. To this end, he needs to put his hands into the dangerous working zone of the machine. A light barrier keeps the cutting process from being initiated. At the same time, the press-down bar is allowed to move down only under the action of a small force in order to avoid bruises and injuries. In the known embodiment, the foot pedal actuates a valve slide to achieve the safety force. A thermally stable safety valve is employed to obtain a hydraulic circuit which is independent on temperatures.

It is the object of the invention to provide a device for controlling a paper cutting machine which requites less expenditure as compared to the state of the art while allowing the saving of energy.

### BRIEF SUMMARY OF THE INVENTION

In the inventive device, at least one of the first circulation valves is defined by an electrically controllable proportional valve, and the proportional valve is driven by an electric control device. It is preferred that both of the two circulation valves for driving the press-down cylinder are constituted by proportional valves.

In the circuit of the press-down cylinder, when at rest, the hydraulic medium flows from the pump through the two circulation valves, specifically the two proportional valves, and back to the tank. The valves generate a relatively low circulation pressure of about 2-3 bars and can be driven up to their maximum working pressure. While pressure is applied in cutting, it is possible to drive the press cylinder at random by driving one of the two proportional valves in a desired manner so that a ramp function can be implemented, for instance, according to which the full working pressure will have built up only after a certain time. The ramp function moves between 10 and 20 bar, for example, over a period of from 100 to 200 ms. An extra damping element, e.g. in the form of a reservoir, may be omitted.

Once the cutting bar reaches its lower position (lower dead-centre position) it becomes possible to switch the circulation valves of the press-down bar circuit over to circulation and the control valve to the press cylinder is switched into the blocking position, which minimizes the energy demand within the press circuit A cutting simulator function can be realized in the inventive device by the fact that a controllable on-off valve and a throttle valve are connected for restriction in parallel with the circulation valves, according to an embodiment of the invention. The circulation valves, which are designed as proportional valves, and the on-off valve help in executing all functions for a cutting simulator function, namely by means a minimal valve technical expenditures. It is possible to carry out a random pressure setting, the proportional valve connected in parallel being designed and driven for a pressure which is by 10% higher. It is important here which one of the two proportional valves carries out the pressure setting. This is prefixed in the electric control device. If a pressure sensor is coupled to the feed line it is also possible to constantly regulate the pressure set over an overall temperature range. To drive the press-down bar in the cutting simulator function, according to an aspect of the invention, a potentiometer may be provided as a signal generator via which the pressure is adjusted on the proportional valve and, hence, in the press cylinder. This makes unnecessary further components as usually are employed in known paper cutting machines.

It was mentioned already that it is desirable for the press-down bar to come to rest on the paper stack gently during its downward movement in some cases. This can also be achieved by means of a pressure sensor controlled proportional valve in the inventive device. Thus, the press-down bar may be caused to set down onto the paper stack at somewhat more than 10 bar, after which the desired press-down force is regulated. Incidentally, a sensor can help in achieving a regulation to a predetermined pressure which does not depend on external conditions such as temperatures or the like.

The invention also makes it possible to achieve a specific surface pressure which is independent on which width the cutting material has. One or more sensors, if employed, allow to determine the width of the material being pressed and to enter it into the computer of the electronic control device. The device then finds out the specific pressure desired and adjusts it via the proportional valve.

Like in the press circuit, two circulation valves are provided in the cutting circuit and, when at rest, cause the hydraulic medium to flow back to the tank. When a cutting is being made both of the circulation valves are driven in order to set the necessary pressure on the control valve of the coupling cylinder. The coupling pressure to be applied by the coupling cylinder depends on the machine type and ranges between about 50 and 100 bar. A braking device causes a stoppage of the knife as soon as the pressure is cut off in order to avoid a knife caster action which is dangerous. According to the invention, a proportional valve via which the desired pressure accumulation can be achieved now is provided also for driving the coupling cylinder. Since the knife movement is not perpendicular, but is under an angle of about 45°, significant sideward forces arise when the cutting bar speeds up. This can cause the machine to migrate if it is not anchored firmly. Moreover, the noise generation is enormous. The proportional valve can help build up the pressure in such a way that the clutch linings apply a soft pressure, which causes the knife to drag for a short time and gently speed up. This reduces the sideward forces considerably and it can make it unnecessary to anchor the machine.

If the knife has become dull it requires to be replaced with another. In this respect, it is known to drive the clutch at short intervals and move the knife to the lower dead-centre position at an inching travel. The coupling pressure may be limited to 30 bar, for example, in an inching mode by means of the inventive control device. This does not necessitate any particular hydraulic extra equipment.

In the known control device for the cutting process or the coupling cylinder, the coupling pressure will act during the entire running period of the knife. In the invention, the coupling pressure is reduced after the end of the cutting process, i.e. when the cutting bar has reached its lower dead-centre so that there is a weaker frictional grip in the clutch which, however, is sufficient to cause the upward movement of the knife. As was mentioned previously a rotary accumulator is incorporated in between the drive of the cutting bar and the gearbox. During the last-mentioned function of lowering the coupling pressure, a saving of energy is achieved to the effect that the rotary accumulator may be charged again already while the cutting bar is moving upwards. Furthermore, the press-down bar is blocked hydraulically at the time indicated, which forces the pump to build up the circulation pressure only, which means another saving of energy.

Likewise, a diagnostic check program may be implemented by means of the inventive control device and two pressure sensors in the two control circuits. The program may be run cyclically during every new start-up or even after a fixed number of operating hours. When in the circulating position, the circulation valves which are constituted by proportional valves according to the invention have to generate a low circulation pressure. If a circulation valve remains closed during the testing phase and a pressure arises higher than a prefixed maximum pressure arises one circulation valve has not opened. The proportional valve and the circulation valve can be driven in succession also in the control circuit of the coupling cylinder, where a pressure buildup must not arise in any event. During their operation, it is also possible to monitor the two control circuits by means of the pressure sensors in order to show an error display if there is a deviation from predetermined setpoints.

In lieu of a second proportional valve as a circulation valve in the control circuit for the press cylinder, a directional valve may be used which has three switching positions, namely a circulating position, a throttling position, and a blocking position. A valve of this type also operates in proportion in order to realize a desired cross-flow section in the throttling position. When at rest, for example, such a valve can implement the second (redundant) circulation function and carry out the pressing function in the pressing process. The valve can provide a pressure regulation in the cutting simulator function, for instance, in order that a small pressure of about 10 to 20 bar is obtained. Hence, the functions of cutting optimization and gentle pressing may also be run with such a valve combination.

### BRIEF DESCRIPTION OF THE SEVERAL VIEWS OF THE DRAWINGS

Two embodiments of the invention will be described below with reference to the drawings.

FIG. 1 shows a hydraulic circuit layout for a control device according to the invention.

FIG. 2 shows a hydraulic circuit layout modified with respect to FIG. 1 for a control device according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

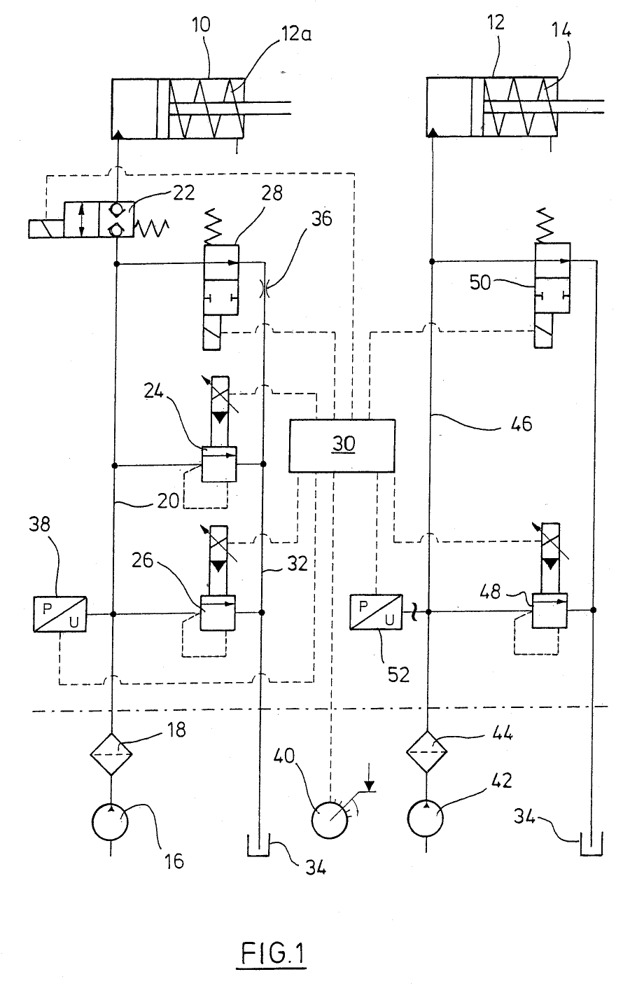

A press cylinder 10 and a coupling cylinder 12 can be recognized in FIG. 1. Both of them are of the one-sided action type where the pistons are restored by a spring 12 and 14, respectively. The press cylinder 10 actuates the press-down bar of a paper cutting machine which is not shown, where if a hydraulic pressure is applied the press-down bar is displaced from the upper dead-centre position to the lower one. The spring 12 provides for a return stroke in the inverse direction. The coupling cylinder 12 actuates the coupling elements of a friction clutch with the clutch being opened or disengaged by means of the spring 14. As is known the clutch serves for building up the drive train between a driving motor, e.g. an electric motor, and the cutting bar, not shown either, of the paper cutting machine, where a worm gear which actuates the cutting bar via a crank mechanism is seated on the output side of the clutch. Such a construction is known per se.

In FIG. 1, a pump 16 delivers a hydraulic medium into a pressure line 20 through a filter 18. The line communicates with the piston space of the press cylinder 10 via a control valve 22. Connected to the pressure line 20 are a first proportional valve 24 and a second proportional valve 26, as is a two-way valve 28. All valves 22 to 28 can be driven by means of an electric control 30 which is outlined only schematically here.

The electric control also includes a processor by which the various functions yet to be described may be executed according to predetermined programs.

The proportional valves 24, 26 may be set to a desired pressure, i e. if they are switched to be fully open the hydraulic medium passes into a tank line 32 which is led to the tank 34. The pressure is varied in the pressure line 20 depending on the way of driving, so that an arbitrary pressure can be generated on the press cylinder 10 if the valve 22 is controlled so as to open, which is done by means of the electric control 30 as well. The valve 28 is a pure on-off valve which either is opened or closed. Its circuit includes a throttle valve 36 which limits the volume of the flow medium passing to the tank 34.

The pressure line 20 also has connected thereto a pressure sensor 38 the signals of which are provided to the electric control device 30.

Finally, FIG. 1 allows to identify a rotary potentiometer 40 the output of which goes to the electric control device 30.

Another pump 42 is coupled, via a filter 44, to another pressure line 46 which communicates with the piston space of the coupling cylinder 12. However, the pump 42 may be omitted if a common pump having an additional flow divider is employed for the two cylinders 10, 12. Connected to the pressure line 46 are a proportional valve 48 and an on-off valve 50 both of which receive control signals from the electric control device 30. The pressure line 46 also has connected thereto a further pressure sensor 52.

The circuit layout shown is sufficient to realize all functions for a paper cutting machine. Those are briefly explained below.

In the inoperative position of the paper cutting machine, it must be sure that the cylinders 10, 12 are not operated. The valves 24, 26 of the press circuit and the valves 48 and 50 of the cutting circuit are opened in such case. This allows the hydraulic medium to freely flow back to the tank 34, a certain circulation pressure of 2-3 bar being acceptable. However, the pressure would be insufficient to cause an actuation of the cylinders 10, 12 even if the control valve 22 was opened. The valve 22 is controlled by the control device so as to open at the outset of the cutting process. The desired press-down force is adjusted via the proportional valve 24, for example, with the proportional valve 26 being driven by a pressure which is higher by about 10 bar. However, the functions of the valves 24, 26 may also be interchanged. Since the press cylinder 10 is to be kept from being loaded at once with the full press-down force the proportional valve 24 is driven by a ramp function of from 10 to 20 bar, for example, over a period of about 100 to 200 milliseconds. The valve 28 may also be closed during the process described, but needs to be closed after the closure of the valves 24, 26 at the latest. Once the press-down bar has reached the point of contact and the cutting bar has completed the cutting process the control valve 22 will be closed. The proportional valves 24, 26 may be opened completely, which minimizes the energy demand in the press circuit.

To keep damage from delicate cutting materials, it is possible to drive the press-down bar in such a way that it sets down gently on the paper stack. This is also done by driving the proportional valve 24, i.e. in response to a sensor which is not shown and finds out when the press-down bar approaches the paper stack. Afterwards, the desired press-down force may be built up again and be regulated to the setpoint predetermined in the electric control device 30 by means of the pressure sensor 38.

If there is a certain press-down force on the press cylinder 10, the press cylinder, under a spring load, travels towards the upper dead-centre position, namely at a relatively slow speed. As soon as the pressure is increased the press-down bar is displaced again towards the lower dead-centre position, which is done at a predetermined pressure. The period of time during which this process is performed may be preset by the control device 30, which causes the proportional valve 24, for example, to temporarily build up a pressure of about <10 bar in the press cylinder (cutting optimization). Another cutting process is released in the described manner subsequently.

The so-called cutting simulator function is achieved by the control device opening the on-off valve 28, by which action the throttle valve 38 restricts the maximum hydraulic fluid volume which is allowed to flow to the press cylinder 10. At this stage, one of the proportional valves 24, 26 prefixes a pressure which is adjusted by the potentiometer 40. The potentiometer is actuated either by the hand or foot of an operator, thus allowing for the adjustment of a predetermined pressure in the press cylinder via one of the proportional valves 24, 26 with the second one, in turn, being set to a pressure which is higher by 10%, This way enables the working pressure to be adjusted between 10 and 20 bar, for example.

The circulation for the cutting circuit is brought about by the proportional valve 48 and the on-off valve 50. A circulation pressure <3 bar is obtained also here. The two valves 48, 50 are closed for cutting and the coupling pressure is adjusted on the proportional valve 48. It ranges between 50 and 100 bar. For a prevention of too intense an acceleration of the cutting bar, it is possible to build up the coupling pressure gently at the beginning so that the clutch will drag more or less. This significantly reduces the sideward forces acting on the cutting machine.

After the lower dead-centre is reached, the valve 48 is set to a lower pressure which is sufficient to move the cutting bar to the upper dead-centre position. As is known the coupling force may be the lower the smaller is the force to be applied to the cutting bar. During the return stroke, it is possible already to re-charge the rotary accumulator which usually is provided, which enables to save energy with the paper cutting machine in operation.

A diagnostic check may be made by means of the pressure sensor 38 and the further pressure sensor 52. When in the circulating position in the press circuit, the two valves 24, 26 require to be opened. The pressure must not exceed a certain level here.

The same holds true for the valves 50, 48 which, when in the circulating position, are only allowed to generate a minimal pressure. The two control circuits for the cylinders 10, 12 may be monitored even when in operation. If the forces to be applied are under a regulation it will be possible to maintain a desired press-down force throughout the range of working temperatures.

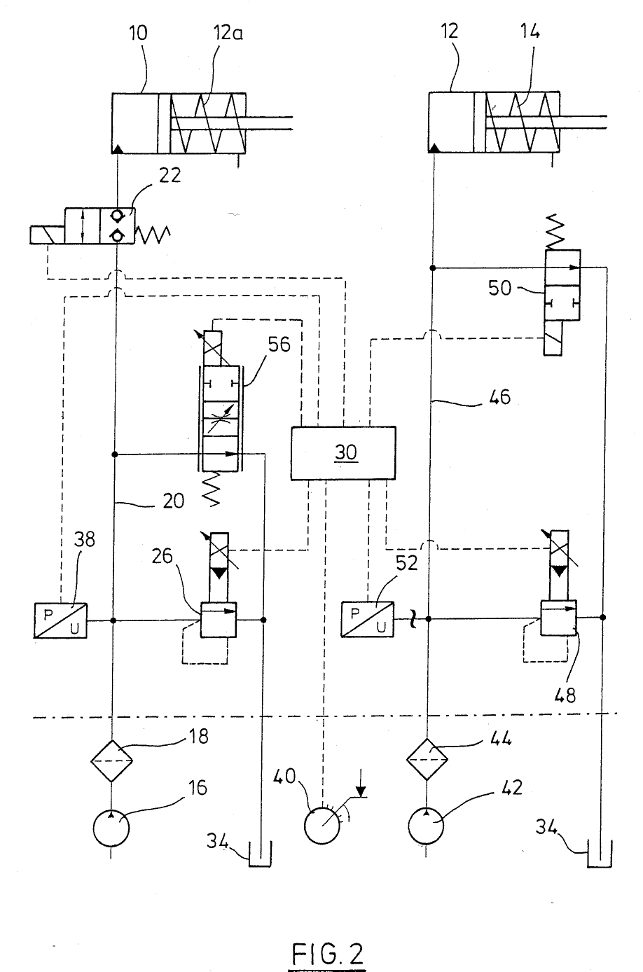

The hydraulic circuit layout of FIG. 2 only differs slightly from the one of FIG. 1. Therefore, like parts are designated by like reference numbers.

In the layout of FIG. 2, the valves 28, 24 of FIG. 1 are substituted for by a three-way valve 56 which also is driven by the electric control device 30. The valve has three switching positions which include a blocking position, a circulating position and a throttling position. The circulating position corresponds to the circulating position of the proportional valve 24 of FIG. 1 The valve 56 is switched into the blocking position in the pressing mode. The throttling position is needed, for instance, during the cutting simulator function to achieve a pressure regulation to a desired safety pressure when the flow rate is prefixed. For example, a pressure of from 10 to 20 bar is set here. The functions of “cutting optimization” and “gentle pressing” may be realized either by the valve 26 or valve 56,

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A device for controlling a paper cutting machine which has a press-down bar and a cutting bar, wherein the press-down bar is operable by a spring-biased single-side action hydraulic press cylinder and the cutting bar is operable by a rotary motor which is adapted to be coupled to a cutting bar via a gearcase and a friction clutch, and wherein the friction clutch is operable by a hydraulic coupling cylinder biased by a spring, comprising a hydraulic pressure source which is connected to the press cylinder via a first pressure line and a controllable on-off valve, two parallel controllable circulation valves which are connected to the pressure line and join the pressure line to the tank when at rest, a controllable cutting simulator valve assembly which restricts the pressure from the press cylinder and the volume of hydraulic medium flowing thereto, a second pressure line leading to the coupling cylinder and joined to the first hydraulic pressure source or a separate second hydraulic pressure source, two controllable second circulation valves which are connected to the pressure line which and join the second pressure line to the tank when at rest, and a control device for driving the individual controllable valves, characterized in that at least one of the first circulation valves (24, 26) is defined by an electrically controllable proportional valve and an electric control device is provided, at least for driving the proportional valve.

2. The device according to claim 1, characterized in that the first two circulation valves are proportional valves (24, 26) and the cutting simulator valve assembly has a controllable on-off valve (28) and a throttle valve (36) for volume restriction,

3. The device according to claim 1, characterized in that the second one of the first circulation valves is a controllable directional valve (56) having three positions which include a blocking position, a throttling position and a circulating position.

4. The device according to claim 1, characterized in that the first pressure line (20) has connected thereto a pressure sensor (38) the outlet of which is coupled to the electric control device (30).

5. The device according to claim 1, characterized in that the electric control device (30) has a sequence program for driving the individual valves which is based on the operation steps of the press-down bar and/or cutting bar.

6. The device according to claim 4, characterized in that the required pressure values for the press cylinder are filed in the electric control device (30) and are compared to the actual pressure values arriving from the pressure sensor (38), for the purpose of regulating the pressure on the press cylinder (10) in the respective operational states.

7. The device according to claim 1, characterized in that the proportional valve (24, 26) is driven from the electric control device (30) via a ramp function for the purpose of slowly building up a pressure on the press cylinder (10) during the start-up phase.

8. The device according to claim 1, characterized in that the electric control device (30) switches the circulation valves into circulation and blocks the on-off valve (22) when the cutting bar has reached its lower dead-centre position.

9. The device according to claim 1, characterized in that the electric control device (30) drives the proportional valve (24, 26) after the press-down bar has reached its lower dead-centre in order to lower the pressure in the pressure line (20) to a reduced value, causing the press-down bar to be raised from a paper stack by a small amount, after which a further pressing cycle of the press-down bar is initiated by the electric control device (30).

10. The device according to claim 1, characterized in that a distance sensor measures the distance of the press-down bar from the paper stack and the electric control device (30) drives the proportional valve (24, 26) so as to temporarily lower the pressure in the pressure line (20) to a reduced pressure level if a signal of the distance sensor detects the approach of the press-down bar to the paper stack,

11. The device according to claim 2, characterized in that a manually operable electric signal generator (40) is connected to the electric control device (30), which opens the on-off valve (28) with the throttle valve (36) electrically and drives the directional valve (56) if the electric signal generator (40) generates a signal and the proportional valve (24, 26) is driven in response to the level of the electric signal.

12. The device according to claim 1, characterized in that a width sensor is provided which measures the width of the paper stack, and the proportional valve (24, 26) is driven by the electric control device (30) so as to cause the press-down bar to produce a predetermined specific surface pressure.

13. The device according to claim 1, characterized in that one of the second circulation valves also is a proportional valve (48) which is adapted to be driven by the electric control device (30).

14. The device according to claim 13, characterized in that the electric control device (30), when the cutting bar is at the upper dead-centre position, drives the proportional valve (48) so as to generate a temporarily lower pressure in the pressure line (46) during a start-up phase of the cutting bar.

15. The device according to claim 13, characterized in that the electric control device (30), after the lower dead-centre position is reached, drives the proportional valve (48) into a reduced pressure in the pressure line (46).

16. The device according to claims 13, characterized in that the second pressure line (46) has connected thereto a second pressure sensor (52) which is coupled to the electric control function (30).
